(19) United States
(12) Patent Application Publication
(10) Pub. No.: US 2010/0187864 A1
(43) Pub. Date: Jul. 29, 2010

(54) VEHICLE STRUCTURE

(75) Inventor: Takuji Tsuchida, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, AICHI (JP)

(21) Appl. No.: 12/670,812

(22) PCT Filed: Jul. 25, 2008
(86) PCT No.: PCT/JP08/63817

§ 371 Date: Jan. 26, 2010

(30) Foreign Application Priority Data
Jul. 26, 2007 (JP) 2007-194655

(51) Int. Cl. B62D 25/20

(52) U.S. Cl. 296/193.07

(57) ABSTRACT

A vehicle structure including a floor tunnel includes: tunnel reinforcing members for reinforcing at least a front portion of the floor tunnel; and a supporting frame combined with the tunnel reinforcing members and side members or a supporting frame combined with the tunnel reinforcing members, the side members, and side sills. The supporting frame is preferably arranged at a front end of the floor tunnel.

### TECHNICAL FIELD

The present invention relates to a vehicle structure having a floor tunnel.

### BACKGROUND ART

A pair of right and left side sills which extend from front side members within an engine room, a pair of right and left side members arranged outside the side sills, etc. are disposed as structural members on the floor of a vehicle body. In order to dispose a propeller shaft, etc. especially in the case of a rear drive vehicle, etc., a floor tunnel which extends in a vehicle longitudinal direction is provided at the center of the floor in a vehicle width direction. Tunnel reinforcements for reinforcing a tunnel portion independently from other surrounding structural members are disposed at the floor tunnel. Additionally, in a vehicle structure described in Patent Citation 1, a tunnel cross member which connects right and left side members is disposed, and a pair of floor cross members which are linearly joined to the tunnel cross member, and connect the side members and side sills externally is disposed.

[Patent Citation 1] JP-A-2006-312351

[Patent Citation 2] JP-U-6-47086

### DISCLOSURE OF INVENTION

In the case of pole (power pole, etc.) frontal collision against a limited region in the vicinity of one side or center of a front surface of a vehicle, or an offset frontal collision, due to transverse folding of a crash box, front side members, etc., EA (Energy Absorption) structural members (front side members, etc.) for absorbing energy ahead of the passenger cabin cannot function effectively compared with a full wrap frontal collision, and cannot sufficiently absorb the excessive load (energy) caused by collision. Therefore, an engine located ahead of the passenger cabin is pushed into the passenger cabin due to the excessive load which could not be absorbed, and the excessive load is input to the floor tunnel (and eventually, the passenger cabin). Since a large mass of a rear structure of the vehicle tends to come out in the forward direction via the side members or side sills due to the reaction of the excessive load, relative movement is generated between the floor tunnel, and the side members and side sills. In the vehicle structure described in Patent Citation 1, only the relative movement between the side members and the side sills can be suppressed, and the excessive load to the floor tunnel cannot be dispersed.

Thus, if the tunnel reinforcements are provided throughout the tunnel portion in a case where it is considered that the proof stress of the tunnel reinforcements is greatly improved, a large increase in mass is caused. Additionally, if the tunnel reinforcements are provided only at the portions of the tunnel portion ahead of the passenger cabin, there is a possibility that transverse folding may be caused on the boundary between a strong strength portion and a weak strength portion due to an excessive load.

Thus, the object of the invention is to provide a vehicle structure which suppresses the relative movement between a floor tunnel and structural members on both sides thereof, and disperses a large load, in a case where the large load is input to a floor tunnel.

The vehicle structure according to the invention is a vehicle structure having a floor tunnel including: tunnel reinforcing members for reinforcing at least a front portion of the floor tunnel; and a supporting frame combined with the tunnel reinforcing members, and members extending in a direction including a vehicle longitudinal component.

In this vehicle structure, the floor tunnel is reinforced by the tunnel reinforcing members, and the tunnel reinforcing members, and the members extending in a direction including a vehicle longitudinal component outside the reinforcing members are combined together by the supporting frame. In a case where a large load is input to the floor tunnel due to a pole frontal collision, an offset frontal collision, etc., in this vehicle structure, the load is transmitted to the supporting frame via the tunnel reinforcing members, and the transmitted load is further transmitted to the members extending in a direction including a vehicle longitudinal component via the supporting frame. This enables the input load to the floor tunnel to be dispersed to the members extending in a direction including a vehicle longitudinal component from the tunnel reinforcing members, and enables a reaction force to be generated in each of the tunnel reinforcing members and the members extending in a direction including a vehicle longitudinal component against each dispersed load. Moreover, in this vehicle structure, the supporting frame suppresses the rearward movement of the floor tunnel caused by the input load, suppresses the forward movement of the members extending in a direction including a vehicle longitudinal component, and suppresses the relative movement between the floor tunnel and the members extending in a direction including a vehicle longitudinal component. As a result, a large reaction force can be generated against the large load to the floor tunnel, and deformation of a passenger cabin can be suppressed as much as possible.

Here, in the above vehicle structure of the invention, the members extending in a direction including a vehicle longitudinal component may be side members.

Additionally, in the above vehicle structure of the invention, the supporting frame may be combined with the tunnel reinforcing members, the side members, and side sills.

In this vehicle structure, the tunnel reinforcing members, the side members outside the tunnel reinforcing members, and side sills outside the side members are combined together by the supporting frame. In a case where a large load is input to the floor tunnel, in this vehicle structure, the load is transmitted to the supporting frame via the tunnel reinforcing members, and the transmitted load is also transmitted to the side sills outside the side members other than the side members via the supporting frame. This enables a large input load to the floor tunnel to be dispersed to the side members and the side sills from the tunnel reinforcing members, and enables a reaction force to be generated in each of the tunnel reinforcing members, the side members, and the side sills against each dispersed load. Moreover, in this vehicle structure, the supporting frame suppresses the rearward movement of the floor tunnel caused by the input load, suppresses the forward movement of the side members and side sills, and suppresses the relative movement between the floor tunnel and the side members and side sills. Additionally, it is even possible to suppress the movement such that the side sills tend to come out in a forward direction relative to the side members. As a result, load can be further dispersed, a larger reaction force can be generated against input load, and local transformation can be suppressed.

In the above vehicle structure of the invention, it is preferable that the supporting frame is arranged at a front end of the floor tunnel. As the supporting frame is located closer to the front end, the tunnel reinforcing members for transmitting load to the supporting frame can be shortened, and mass can be reduced.

### BRIEF DESCRIPTION OF DRAWINGS

FIG. 1 is a plan view showing an underbody structure according to a first embodiment.

FIG. 2 is a perspective view of the underbody structure of FIG. 1.

FIG. 3 is a front view of the underbody structure of FIG. 1.

FIG. 4 is a front view of an underbody structure including another supporting frame.

FIG. 5 is a plan view showing an underbody structure according to a second embodiment.

### BEST MODE FOR CARRYING OUT THE INVENTION

Embodiments of a vehicle structure according to the invention will be described below with reference to the drawings.

In this embodiment, the vehicle structure according to the invention is applied to an underbody structure in a rear drive vehicle. The underbody structure according to this embodiment includes a supporting frame, and tunnel reinforcements and structural members on both sides thereof are interconnected by the supporting frame. In this embodiment, the shape of the supporting frame and the combined destination of the supporting frame are two different forms.

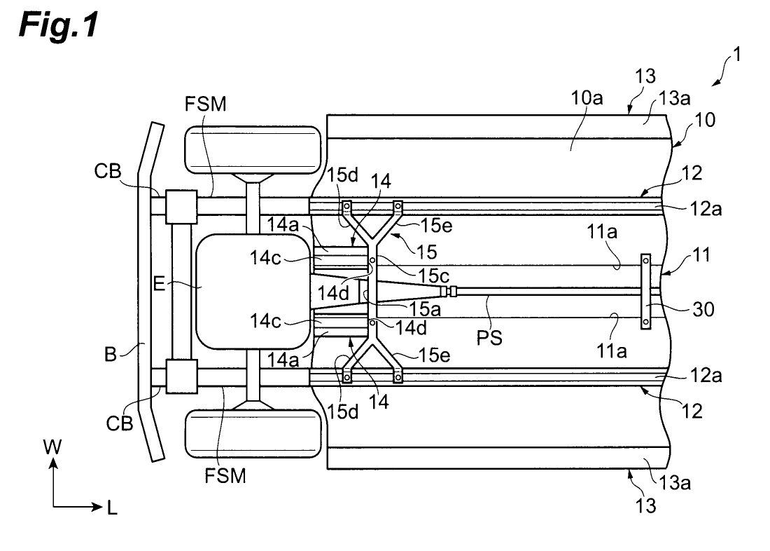

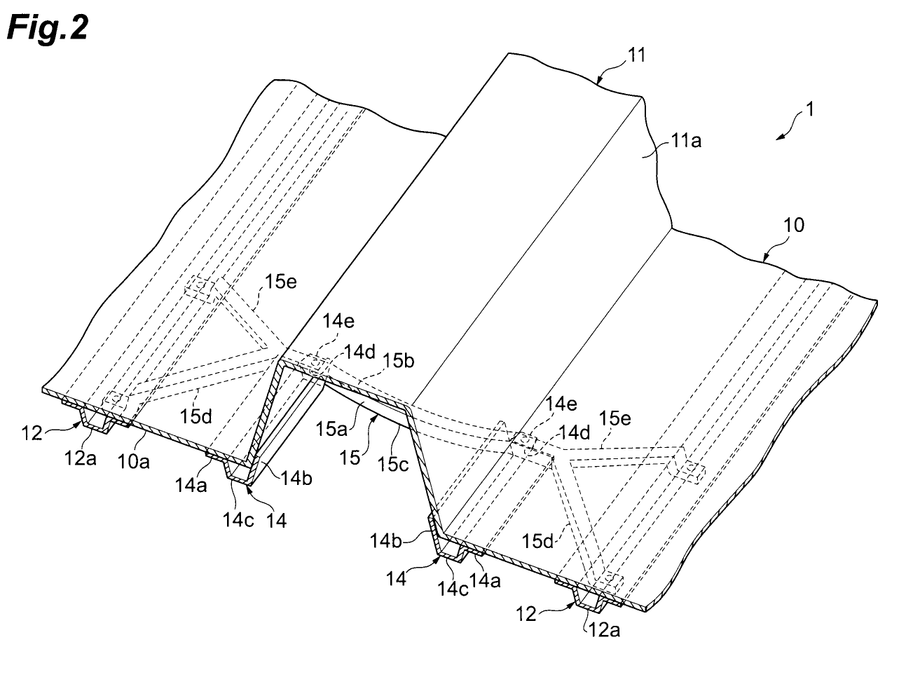

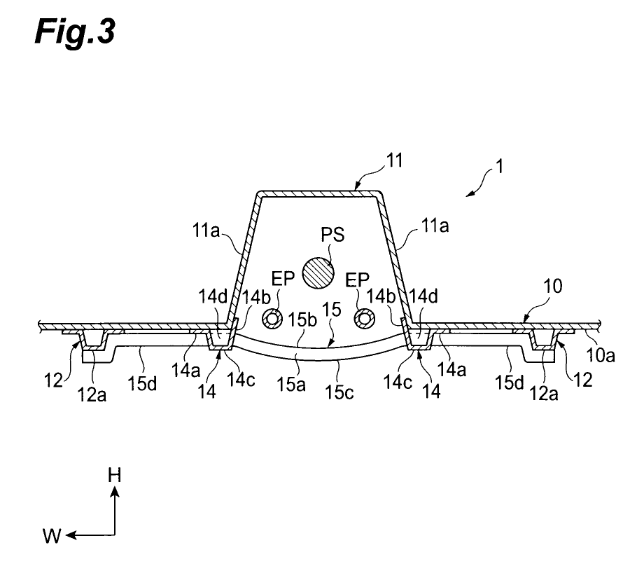

An underbody structure 1 according to a first embodiment will be described with reference to FIGS. 1 to 3. FIG. 1 is a plan view showing the underbody structure according to the first embodiment. FIG. 2 is a perspective view of the underbody structure of FIG. 1. FIG. 3 is a front view of the underbody structure of FIG. 1.

In the underbody structure 1, a floor 10 is disposed at a bottom of a vehicle body. A tunnel portion 11, which extends in a vehicle longitudinal direction (L), is provided at the center of the vehicle body in a vehicle width direction (W) in the floor 10. The tunnel portion 11 has a convex shape which protrudes upward from the floor 10 in a vehicle height direction (H), and is opened at a lower portion thereof. A propeller shaft PS and exhaust pipes EP and EP are arranged inside the tunnel portion 11. In order to reinforce the tunnel portion 11, a reinforcing member 30 is provided on the vehicle rear side of the tunnel portion 11 so as to extend in the vehicle width direction of the tunnel portion 11.

Additionally, a pair of right and left side members 12 and 12, which extends from front side members FSM and FSM within an engine room in the vehicle longitudinal direction (L), is disposed on the right and left outsides of the tunnel portion 11 in the vehicle width direction (W) in the floor 10. Each side member 12 is a supporting member, and is a longitudinal (lengthwise member) which has a longitudinal component. Each side member 12 is a supporting member, and is a longitudinal member (lengthwise member) having a longitudinal component. Each side member 12 has a hat shape (in sectional view) having a flange portion, and the flange portion is joined to the floor 10. Additionally, a pair of right and left side sills (rockers) 13 and 13 which extends in the vehicle longitudinal direction (L) is disposed outside the side members 12 and 12, respectively, in the vehicle width direction (W) in the floor 10.

Moreover, the underbody structure 1 includes a pair of right and left tunnel reinforcements 14 and 14 of one pair of right and left, and a supporting frame 15. In addition, in the first embodiment, each tunnel reinforcement 14 corresponds to each tunnel reinforcing member set forth in the Claims, and the supporting frame 15 corresponds to the supporting frame set forth in the Claims.

The tunnel reinforcement 14 is arranged to a position which touches the supporting frame 15 from a front end of the tunnel portion 11 in the vehicle longitudinal direction (L), and is disposed at an undersurface 10a of the floor 10 at an outer edge of the tunnel portion in the vehicle width direction (W). That is, the tunnel reinforcement 14 is provided at a corner formed by an inner surface of a side wall 11a of the tunnel portion 11, and the undersurface 10a of the floor 10. The tunnel reinforcement 14 has a convex shape which protrudes downward from the floor 10 in the vehicle height direction (H), and has a flange portion 14a on the outer side thereof and has a joining portion 14b on the inner side thereof. The flange portion 14a is a surface along the undersurface 10a of the floor 10, and is joined to the undersurface 10a. The joining portion 14b is a surface along the inner surface of the side wall 11a of the tunnel portion 11, and is joined to the inner surface of the side wall 11a. In addition, it is desirable that the flange portion 14a of the tunnel reinforcement 14 is provided if necessary in consideration of required performance, etc. In a case where the tunnel reinforcement 14 does not have the flange portion 14a, for example, the tunnel reinforcement 14 is arranged so that a void is provided between the undersurface 10a of the floor 10 at the outer edge of the tunnel portion 11, and the tunnel reinforcement 14, that is, so that the tunnel reinforcement 14 covers the whole outer edge of the tunnel portion 11 continuously. Otherwise, the tunnel reinforcement 14 may have a joining portion on the outer side thereof and have a flange portion on the inner side thereof, and it may be that only the flange portion is joined to the surface along the inner surface of the side wall 11a of the tunnel 11, and the joining portion is joined to the undersurface 10a of the floor 10.

At the rear end of the tunnel reinforcement 14, a rear end 14d is constructed as a bottom surface 14c is bent upward along a front surface 15a of the supporting frame 15, and a flange portion 14e is constructed as the undersurface is bent rearward along the undersurface 10a of the floor 10. The rear end wall 14d is arranged in a state where the rear end wall touches the front surface 15a of the supporting frame 15. Additionally, the flange portion 14e is arranged in a state where the flange portion is sandwiched between an upper surface 15b of the supporting frame 15, and the undersurface 10a of the floor 10, and touches the upper surface 15b and the undersurface 10a, respectively. A bolt-hole is formed in the flange portion 14e. In addition, even at the front end of the tunnel reinforcement 14, a front end wall may be constructed as the bottom surface 14c is bent upward.

The supporting frame 15 is arranged at the front end of the tunnel portion 11 in the vehicle longitudinal direction (L), and is arranged between the right and left side members 12 and 12 in the vehicle width direction (W). The supporting frame 15 includes a trunk portion 15c, and right and left front leg portions 15d and 15d and rear leg portions 15e and 15e.

The trunk portion 15c has a quadrangular prismatic shape, and has a shape which is bent a little downward. The trunk portion 15c has a length such that the trunk portion sufficiently straddles the right and left tunnel reinforcements 14 and 14 in the vehicle width direction (W). Bolt-holes are respectively formed in the positions corresponding to bolt-holes of the flange portions 14e and 14e of the tunnel reinforcements 14 and 14 in the trunk portion 15c. At each end of the trunk portion 15c, the front leg portion 15d and the rear leg portion 15e branch off, the front leg portion 15d extends toward the front side, and the rear leg portion 15e extends toward the rear side.

The front leg portion 15d has a quadrangular prismatic shape, and its distal end is formed in the shape of stairs along the convex shape of the side member 12. The front leg portion 15d has one end connected to the end of the trunk portion 15c in the vehicle width direction (W), and the other end extending to the side member 12. The position of the other end of the front leg portion 15d is in front of the trunk portion 15c in the vehicle longitudinal direction (L), and is near the front end of the floor 10. A bolt-hole is formed in the place where the bolt-hole overlaps a bottom surface 12a of the side member 12 at the other end of the front leg portion 15d. In addition, a bolt-hole is formed in the position corresponding to the bolt-hole of the front leg portion 15d, even in the bottom surface 12a of the side member 12.

The rear leg portion 15e has a quadrangular prismatic shape, and its distal end is formed in the shape of stairs along the convex shape of the side member 12. The rear leg portion 15e has one end connected to the end of the trunk portion 15c in the vehicle width direction (W), and the other end extending to the side member 12. The position of the other end of the rear leg portion 15e is behind the trunk portion 15c in the vehicle longitudinal direction (L). A bolt-hole is formed in the place where the bolt-hole overlaps the bottom surface 12a of the side member 12 at the other end of the rear leg portion 15e. In addition, a bolt-hole is formed in the position corresponding to the bolt-hole of the rear leg portion 15e, even in the bottom surface 12a of the side member 12.

The supporting frame 15 constructed in this way is arranged in the position where the front surface 15a touches the rear end walls 14d and 14d of the right and left tunnel reinforcements 14 and 14 in the vehicle longitudinal direction (L) and is arranged in a state where the upper surface 15b touches the flange portions 14e and 14e of the tunnel reinforcements 14 and 14. Moreover, the supporting frame 15 is arranged so that the trunk portion 15c straddles the right and left tunnel reinforcements 14 and 14 in the vehicle width direction (W), and the outer ends of the right and left front leg portions 15d and 15d and rear leg portions 15e and 15e are respectively located on the bottom surfaces 12a and 12a of the right and left side members 12 and 12. Also, the bolt-holes of the trunk portion 15c are respectively aligned with the bolt-holes of the flange portions 14e and 14e of the tunnel reinforcements 14 and 14, and the bolt-holes of the front leg portions 15d and 15d and rear leg portions 15e and 15e are aligned with the bolt-holes of the bottom surfaces 12a and 12a of the side members 12 and 12, and thereby, these portions are fixed by bolt fastening, respectively. As such, the supporting frame 15 interconnects the tunnel reinforcements 14 and 14 and the right and left side members 12 and 12, and serves as a load dispersion member. Additionally, the supporting frame 15 is able to interconnect right and left tunnel reinforcements 14 and 14 in the width direction, and transmit load. In this way, the supporting frame 15 has a function to transmit load in the vehicle width direction (W).

The actions in the underbody structure 1 in a case where an excessive load is input to a limited region in the vicinity of the center of a front surface of a vehicle due to a pole frontal collision, etc will be described with reference to FIGS. 1 to 3. If an excessive load is input to the vicinity of the center of a front surface of a vehicle, a bumper B is bent in a U-shape, crash boxes CB and CB and front side members FSM and FSM are transversely folded, and a sufficient amount of EA is not obtained by these EA structural members. Therefore, an engine E is pushed into a passenger cabin, and an excessive load (energy caused by collision) is input to the tunnel portion 11. Thereby, the tunnel portion 11 tends to fall rearward, and a large mass of a rear structure of the vehicle tends to come out in a forward direction via the side members 12 and 12, etc. due to the reaction of the excessive load.

At this time, in the underbody structure 1, the excessive load from the front of the tunnel portion 11 is input to the tunnel reinforcements 14 and 14. In the tunnel reinforcements 14 and 14, a reaction force is generated against the input load, and the input load is transmitted to the supporting frame 15 in contact with the rear end walls 14d and 14d. In the supporting frame 15, the transmitted load is transmitted to the right and left side members 12 and 12, whereby the load is dispersed. In the right and left side members 12 and 12, a reaction force is generated against the transmitted load. Moreover, in the supporting frame 15, the rearward movement of the tunnel portion 11 (tunnel reinforcements 14 and 14) and the forward movement of the side members 12 and 12 is suppressed, and the relative movement between the tunnel portion 11 and the side members 12 and 12 is suppressed. By these actions, the input of an excessive load to a passenger cabin can be suppressed, and the deformation of the passenger cabin can be suppressed (prevented).

Incidentally, if load (energy caused by collision) is input to the vehicle, in the vehicle, the load is absorbed by force (reaction force against load)×deformation volume. Accordingly, as a large reaction force is generated, the deformation volume can be suppressed. Thus, by dispersing the load received by the tunnel reinforcements 14 and 14 to the side members 12 and 12 in this underbody structure 1, a reaction force can be generated in the tunnel reinforcements 14 and 14 and side members 12 and 12, respectively, whereby a large reaction force can be generated. This can reduce the deformation volume (especially the deformation volume of a passenger cabin) in a vehicle.

According to this underbody structure 1, by interconnecting the tunnel reinforcements 14 and 14 and the side members 12 and 12 by the supporting frame 15, it is possible to disperse the load input to the tunnel reinforcements 14 and 14 to the right and left side members 12 and 12, and it is possible to suppress the relative movement between the tunnel portion 11 and the side members 12 and 12. This can suppress or prevent any deformation of a passenger cabin as much as possible.

Moreover, in the underbody structure 1, the supporting frame 15 has the front leg portion 15d, and the rear leg portions 15e, and makes a support at two front and rear points. Thus, the load per point can be lessened and the load can be more efficiently dispersed. Additionally, in the underbody structure 1, the length of the tunnel reinforcements 14 and 14 can be shortened by arranging the supporting frame 15 at the front end of the tunnel portion 11. Thus, the mass caused by the tunnel reinforcements 14 can be reduced, and weight saving can be achieved.

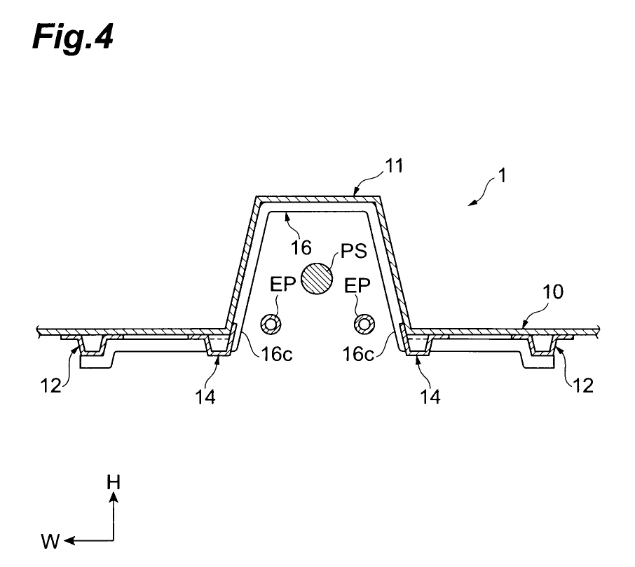

A supporting frame 16 having another shape will be described with reference to FIG. 4. The supporting frame 16, similarly to the supporting frame 15, includes a trunk portion 16c, and right and left front leg portions and rear leg portions. The supporting frame 16 is different from the supporting frame 15 only in the shape of the trunk portion 16c. The trunk portion 16c has a shape along the inner surfaces of the tunnel portion 11, and has a convex shape which protrudes upward in the vehicle height direction (H). Accordingly, the supporting frame 16 has a shape along the whole tunnel portion 11 in the vehicle width direction (W).

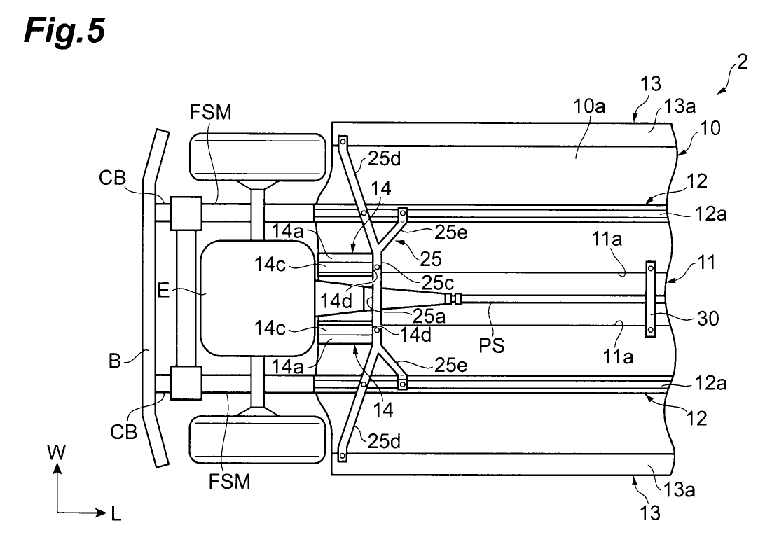

An underbody structure 2 according to a second embodiment will be described with reference to FIG. 5. FIG. 5 is a plan view showing the underbody structure according to the second embodiment. In addition, in the underbody structure 2, the same components as those of the underbody structure 1 according to the first embodiment are denoted by the same reference numerals, and the description thereof is omitted.

The underbody structure 2 is different in the shape of the supporting frame 25 and the combined destination of the supporting frame 25 as compared with the underbody structure 1. In addition, in the second embodiment, the supporting frame 25 corresponds to the supporting frame set forth in the Claims.

The supporting frame 25 is arranged at the front end of the tunnel portion 11 in the vehicle longitudinal direction (L), and is arranged between right and left sills 13 and 13 in the vehicle width direction (W). The supporting frame 25, similarly to the supporting frame 15 according to the first embodiment, includes a trunk portion 25c, and right and left front leg portions 25d and 25d and rear leg portions 25e and 25e, and is substantially X-shaped (in plan view). The supporting frame 25 is different from the supporting frame 15 only in the shape of the front leg portion 25d.

The front leg portion 25d has a quadrangular prismatic shape, and its distal end has a shape along the side sill 13. The front leg portion 25d has one end connected to the end of the trunk portion 25c in the vehicle width direction (W), and the other end extending to the side sill 13. The position of the other end of the front leg portion 25d is in front of the trunk portion 25c in the vehicle longitudinal direction (L), and is near the front end of the floor 10. A bolt-hole is formed in the place where the bolt-hole overlaps a bottom surface 13a of the side sill 13 at the other end of the front leg portion 25d. In addition, a bolt-hole is formed in the position corresponding to the bolt-hole of the front leg portion 25d, even in the bottom surface 13a of the side sill 13.

The supporting frame 25 constructed in this way is arranged in the position where the front surface 25a touches the rear end walls 14d and 14d of the right and left tunnel reinforcements 14 and 14 in the vehicle longitudinal direction (L) and is arranged in a state where the upper surface touches the flange portions of the tunnel reinforcements 14 and 14. Moreover, the supporting frame 25 is arranged so that the trunk portion 25c straddles the right and left tunnel reinforcements 14 and 14 in the vehicle width direction (W), the outer ends of the right and left front leg portions 25d and 25d are respectively located on the bottom surfaces 13a and 13a of the right and left side sills 13 and 13, and the outer ends of the right and left rear leg portions 25e and 25e are respectively located on the bottom surfaces 12a and 12a of the right and left side members 12 and 12. Also, the bolt-holes of the trunk portion 25c are respectively aligned with the bolt-holes of the flange portions of the tunnel reinforcements 14 and 14, the bolt-holes of the front leg portions 25d and 25d are aligned with the bolt-holes of the bottom surfaces 13a and 13a of the side sills 13 and 13, the bolt-holes of the rear leg portions 25e and 25e are aligned with the bolt-holes of the bottom surfaces 12a and 12a of the side members 12 and 12, and thereby, these portions are fixed by bolt fastening, respectively. As such, the supporting frame 25 interconnects the tunnel reinforcements 14 and 14 and the right and left side members 12 and 12 and side sills 13 and 13, and serves as a load dispersion member.

The actions in the underbody structure 2 when an excessive load is input to a limited region in the vicinity of the center of a front surface of a vehicle due to a pole frontal collision, etc will be described with reference to FIG. 5. As described in the first embodiment, if an excessive load is input to the tunnel portion 11, this excessive load is input to the tunnel reinforcements 14 and 14 even in the underbody structure 2. In the tunnel reinforcements 14 and 14, a reaction force is generated against the input load, and the input load is transmitted to the supporting frame 25 in contact with the rear end walls 14d and 14d. In the supporting frame 25, the transmitted load is transmitted to the right and left side members 12 and 12 and transmitted to the right and left side sills 13 and 13, whereby the load is dispersed. In the right and left side members 12 and 12, a reaction force is generated against the transmitted load. Additionally, in the right and left side sills 13 and 13, a reaction force is generated against the transmitted load. Moreover, in the supporting frame 25, the rearward movement of the tunnel portion 11 is suppressed, the forward movement of the side members 12 and 12 and side sills 13 and 13 is suppressed, and the relative movement between the tunnel portion 11 and the side members 12 and 12 and side sills 13 and 13 is suppressed. By these actions, the input of an excessive load to a passenger cabin can be suppressed, and the deformation of the passenger cabin can be suppressed (prevented).

According to this underbody structure 2, by interconnecting the tunnel reinforcements 14 and 14 and the side members 12 and 12 and side sills 13 and 13 by the supporting frame 25, it is possible to disperse the load input to the tunnel reinforcements 14 and 14 to the right and left side members 12 and 12 and side sills 13 and 13, and it is possible to suppress the relative movement between the tunnel portion 11 and the side members 12 and 12 and side sills 13 and 13. Additionally, it is possible to suppress even the movement such that the side sills 13 and 13 tend to come out forward relatively to the side members 12 and 12. In particular, in the underbody structure 2, load can be dispersed not only to the side members 12 and 12 but to the side sills 13 and 13. Thus, more load can be dispersed, a larger reaction force can be generated against input load, and local transformation can also be suppressed. This can suppress or prevent any deformation of a passenger cabin as much as possible.

Although the embodiments according to the invention have been described hitherto, the invention may be implemented in various forms without being limited to the above embodiments.

For example, in this embodiment, the invention has been applied to a rear drive vehicle. However, the invention can be applied to other vehicles having a floor tunnel.

Additionally, in this embodiment, examples in which the supporting frame is combined with the tunnel reinforcements and the side members, or is combined with the tunnel reinforcements and the side members and side sills have been described. However, the targets to be connected are not limited to this. For example, the supporting frame may be combined with members, such as rockers and pillars, which extend in a direction including a vehicle longitudinal component. Also, even in the case where the supporting frame is combined with only the side sills or only the rockers, the operational effects described in this embodiment can be obtained. Preferably, the supporting frame may be combined with a member which extends in a direction including a vehicle longitudinal component as well as being combined with a floor panel. By constructing the invention in this way, the operational effects described in this embodiment can be further achieved.

Additionally, in this embodiment, the supporting frame is adapted to be disposed at the front end of a tunnel portion. However, the supporting frame may be disposed behind the front end if the above-described operational effects can be obtained. Additionally, in this embodiment, the tunnel reinforcements which reinforce only the front end of the tunnel portion are adopted. However, tunnel reinforcements which extend to the rear from the front end may be adopted. In particular, in a case where the supporting frame has to be arranged behind the front end due to an arrangement space, it is necessary to extend the tunnel reinforcements at least to this position.

Additionally, in this embodiment, the supporting frame is formed substantially in an X shape (in plan view). However, the supporting frame may have other shapes if the supporting frame can be combined with the tunnel reinforcements and the side member or can be combined with the tunnel reinforcements and the side members and side sills, and the above-described operational effects can be obtained. For example, the supporting frame may be formed substantially in a V shape (in plan view), and the places where the supporting frame is combined with the side members, etc. may be located behind the places where the supporting frame is combined with the tunnel reinforcements.

Additionally, in this embodiment, the supporting frame is described as a polyhedron. However, for example, similarly to the side members, the supporting frame may be constituted by a member in which a convex portion is formed below by pressing.

Additionally, in this embodiment, examples in which the supporting frame is combined with the tunnel reinforcements and the side members by bolts, as well as combined with the tunnel reinforcements and the side members and side sills by bolts have been described. However, the means for connection with the supporting frame not limited to the fixation by bolts. For example, joining may be made by welding, bonding may be made with adhesive, integral forming may be made, or connection may be made by providing a connecting portion.

### INDUSTRIAL APPLICABILITY

In the invention, the tunnel reinforcing members, and the structural members (side members, etc.) outside the reinforcing members are interconnected by the supporting frame. Thereby, even in a case where a large load is input to a floor tunnel, the relative movement between the floor tunnel and the outside structural members can be suppressed, load can be dispersed, and deformation of a passenger cabin can be suppressed (prevented).

1-4. (canceled)

5. A vehicle structure having a floor tunnel comprising:
tunnel reinforcing members provided on right and left sides of the floor tunnel to reinforce at least a front portion of the floor tunnel; and
a supporting frame combined with the right and left tunnel reinforcing members, and right and left members extending in a direction including a vehicle longitudinal component and provided on right and left sides of the floor tunnel so as to connect the tunnel reinforcing members and the right and left members together respectively.

6. The vehicle structure according to claim 5,
wherein the supporting frame is provided across the floor tunnel in a vehicle width direction.

7. The vehicle structure according to claim 5, wherein the members are side members.

8. The vehicle structure according to claim 7,
wherein the supporting frame is combined with the right and left tunnel reinforcing members, the right and left side members, and side sills provided on right and left sides of the floor tunnel so as to connect the tunnel reinforcing members, the right and left side members, and the side sills together, respectively.

9. The vehicle structure according to claim 8,
wherein the supporting frame is arranged at a front end of the floor tunnel.
